(19) United States
(12) Patent Application Publication
(10) Pub. No.: US 2011/0251725 A1
(43) Pub. Date: Oct. 13, 2011

(54) UTILITY CONTROL SYSTEM

(76) Inventor: MARK KIT JIUN CHAN, Hongkong (CN)

(21) Appl. No.: 13/081,617

(22) Filed: Apr. 7, 2011

Related U.S. Application Data
(60) Provisional application No. 61/321,913, filed on Apr. 8, 2010.

(51) Int. Cl. G05D 23/19; G06F 17/00

(52) U.S. Cl. 700/277

(57) ABSTRACT

A utility control system governs provision of genuine on-demand lighting, as well other utilities as in heating, ventilation and air conditioning (“HVAC”) in territories of a building in accordance with occupant demand. In lighting control, the present invention enacts on-demand illumination anterior to the occupant entering a normally dimmed/unlighted territory; lighting is provided immediately anterior to occupant entry into an oncoming territory. As the occupant leaves each territory, lighting provision is suspended/terminated in that territory for energy conservation. Signals and commands received by the utility control system from a plurality of override switches, interactive sensors and occupancy sensors within each monitored territory, as well as the control units of an elevator control system (“ECS”), a Building Management System (“BMS”) and a client computer govern the utility control system for configuring automated lighting provision. The utility control system predicts an occupant traversal path and provides the occupant with the best-suited lighted environments in each territory of the occupant traversal path.

### PRIORITY DATE

This application claims priority rights in accordance with provisional application 61/321,913 filed on Apr. 8, 2010.

### BACKGROUND OF THE INVENTION

1. Field of the Invention

The present invention relates in particular to a sophisticated utility control system with a major breakthrough—genuine on-demand lighting provision. Illumination is activated immediately anterior to occupant entry into an oncoming territory such that the occupant is not exposed to light fixture brightening during the illumination process. Subsequent occupancy traffic and departure from a territory is tracked and analyzed by the controller for determination of illumination extinguishment.

2. Description of the Prior Art

Existing utility control systems control lighting and other utilities characterized in HVAC in conformance with occupancy detection and preconfigured responses. Problems arise as illumination in a normally dimmed, sensor monitored territory is activated after sensor detection of an occupant. In addition, unused lighting and other utilities are provided in unattended territories during preconfigured time periods. There is a need in the art for a system to provide on-demand lighting anterior to detection of an occupant's actual presence in the territory and illumination distinguishment after occupant departure.

### SUMMARY OF THE INVENTION

The invention relates to a utility control system that governs lighting and other utility provision to building territories (“territories”). A primary object of the invention is to pinpoint occupant location and predict the occupant movement to a new location and to activate on-demand utility provision and in particular lighting provision to optimize energy efficacies.

One aspect of the invention relates to illumination of light groups and scene alterations by a modular controller governing a corresponding zone of monitored territories in conformity with embedded control methods and received sensor signals. At least one override switch is installed in each building territory for the sending of command signals to extend illumination upon activation, as well a link with the ECS to receive elevator scheduler information. In another aspect, the invention relates to on-demand utility control system, in particular a utility control apparatus governing on-demand lighting and utility control in accordance with the prediction of an occupant traversal path based on signals received from a combination of sensors and information from the ECS.

In yet another aspect, the utility control system conveys signals to the ECS regarding occupancy in monitored territories, including corridors and elevator halls, for a specific landing/destination floor. Related information may be used by the ECS for determination of elevator related control and operation.

### BRIEF DESCRIPTION OF THE DRAWINGS

The drawings, constitute various embodiments of the present invention and serve to depict the control infrastructure and operating principles.

FIG. 1 illustrates an exemplary building environment comprising a zone governed by the utility control system.

FIG. 2 illustrates an interactive sensor using various technologies and operation principles.

FIG. 3 is a flow diagram illustrating the control method of the utility control system in operation with real-time ECS operation information.

FIG. 4 illustrates an exemplary passive infrared (“PIR”) sensor performing a diagnosis function in conformity with control signals receiving from a controller.

FIG. 5 illustrates interaction of apparatuses of an exemplary modular utility control system governing one building zone.

FIG. 6 illustrates an exemplary implementation of antecedent illumination in a building environment.

FIG. 7 is a flowchart illustrating a control method of the present invention for activating antecedent illumination and an occupancy verification process.

### DETAILED DESCRIPTION

The present invention may be better understood with reference to embodiments illustrated by the supporting drawings. However, the invention is not restricted to specific apparatuses, technologies, methods or particular protocols, which may be modified or substituted by equivalent counterparts or new approaches to serve similar purposes or functions as long as the overall operation and performance remain unimpeded and unaltered in principle. Terminology and protocol used herein is to describe particular embodiments and is not intended to be limiting in scope.

### Terminology

### Antecedent Illumination

Illumination in a normally dimmed/unlighted territory is activated immediately anterior to occupant arrival and visual notification, wherein the occupant is evaded from the brightening process.

### Client Computer

A network linked electronic device such as a microcomputer or a handheld personal digital assistant (“PDA”), etc.

### Electrical Device

Electrically operated devices controlled by the utility control system including but not limited to light fixtures, occupancy sensors and the client computer.

### Grace Time Period

Each occupant entering a territory from another territory is assigned a grace time period by the controller, during which lighting and other utility provision is to continue without disruption.

### Illumination/Illumination Extinguishment

Illumination of lighting in the invention description indicates a process of power connection or a boost from a power reduction mode to an operation mode having higher lighting intensity up to 100%. Illumination extinguishment denotes lighting entering a power reduction mode.

### Occupancy Sensor

A sensor monitoring occupancy and occupant location within a territory and sending sensor signal to the controller upon detecting the occupant through PIR sensing, laser sensing, imaging capturing and processing, etc; or, a sensor detecting the traversing occupant through active sensing of a chip embedded PDA using RFID sensing and WiFi sensing, etc.

### Power Reduction Mode

An electrical device may be switched from a power reduction mode indicating either a standby mode with reduced or minimal power consumption or total power disconnection to an operation mode with full power connection to electricity and readiness for intended operation.

### Territory and Zone

A zone within a building is monitored by a controller of the utility control system and is comprised of at least one territory. As the traversing occupant departing from the present territory enters an oncoming territory adjacent to the present territory and reaches a destination territory, the occupant traversal path is terminated by the controller.

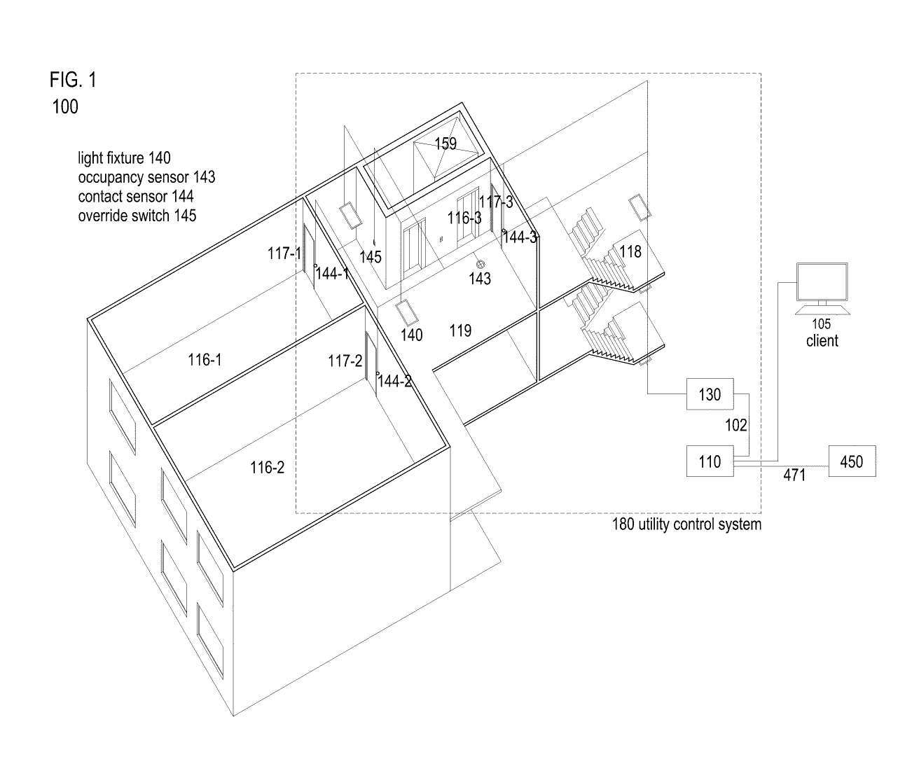

FIG. 1 illustrates an exemplary building environment 100 in which utility control system 180 monitors occupancy and controls provision of lighting. Controller 130 of utility control system 180 implements the operation and is communicatively linked to hub 110 via bus 102. Note that although wired connections are shown in FIG. 1, wireless communication of control signals can also be used by the present invention. Real-time monitoring of environment 100 and control of the operation by management is enabled through client 105, which is also linked (wired or wireless) to hub 110. Client 105 sends configurations and commands to controller 130 and receives operation information, such as power consumption, apparatus status, etc. from controller 130.

An exemplary zone encompasses a territory excluding unit 116-1, unit 116-2 and elevator car (“car”) 159; the zone includes a plurality of light fixtures 140, occupancy sensors 143, interactive sensors 144 and override switch 145 which are communicatively linked to controller 130 through wired or wireless linkages. Utility control system 180 provides lighting in the territory in anticipation of an arriving occupant.

In one embodiment, the occupant (not shown) may enter the unattended elevator hall 119 from unit 116-1, unit 116-2 or stairs 118. Prior to making entry, the occupant triggers interactive sensor 144-1, 144-2, or 144-3, at the opening of the corresponding door 117-1, 117-2, or 117-3. A signal is sent by one or more of the interactive sensors to controller 130, which then brightens light fixtures 140 from a power reduction mode to an operation mode with the light intensity ramped up to a lux level preconfigured by controller 130.

In another embodiment, the controller 130 obtains information regarding passenger arrival (not shown) in the unattended elevator hall 119 from the landing car 159. An elevator car detection section (not shown)—communicatively linked with controller 130 detecting car landing—sends a signal to controller 130 upon landing of car 159; controller 130 brightens light fixtures 140 after landing of car 159 and anterior to the elevator door opening in doorway 116-3. In an alternative embodiment, ECS 450 sends information 471 (discussed in detail below) comprising landing schedules of car 159 to controller 130; controller 130 brightens light fixtures 140 after landing of car 159 and anterior to door opening in doorway 116-3.

Each arriving passenger to the elevator hall 119 is assigned a grace time period; which may be preconfigured through client 105 and is initiated by one or a combination of occupancy sensors, interactive sensors, elevator car detection sections, the ECS, etc. upon detection of the occupant entering into an oncoming, normally dimmed territory. Upon depletion of the grace time period, controller 130 dims light fixtures 140 in one or more territories after implementing the occupancy verification process for ascertainment of occupant departure in the respective territories.

### Adaptive Control

Information pertaining to units 116-1 and 116-2 including but not limited to unit numbers, occupant identifications and associated parking spaces in a building parking garage (not shown), etc. is stored in the memory means of controller 130. Occupant entry and exit through units 116-1 and 116-2 trigger respective interactive sensors 144-1, 144-2; related patterns pertaining to each unit may be utilized by controller 130 for adaptive control in the automated utility provision including but not limited to lighting provision with minimized switching cycles between a power reduction mode and an operation mode. An inferred occupant traversal path and path destination may be projected by controller 130 in accordance with occupant information tagged with interactive sensors 144-1 and 144-2.

Further, the duration of an operation state of the interactive sensors 144-1 and 144-2 may be utilized by controller 130 for composition of the operation data in adaptive control. In one exemplary embodiment, occupant entry/exit patterns contributed from unit 116-1 may be eliminated by controller 130 in control of automated utility provision for elevator hall 119 in accordance with the calculated percentage possibility in unit 116-1 being vacated or change of tenants based on the signals sent from interactive sensor 144-1 indicating frequencies and time durations of door 117-1 being in the open state.

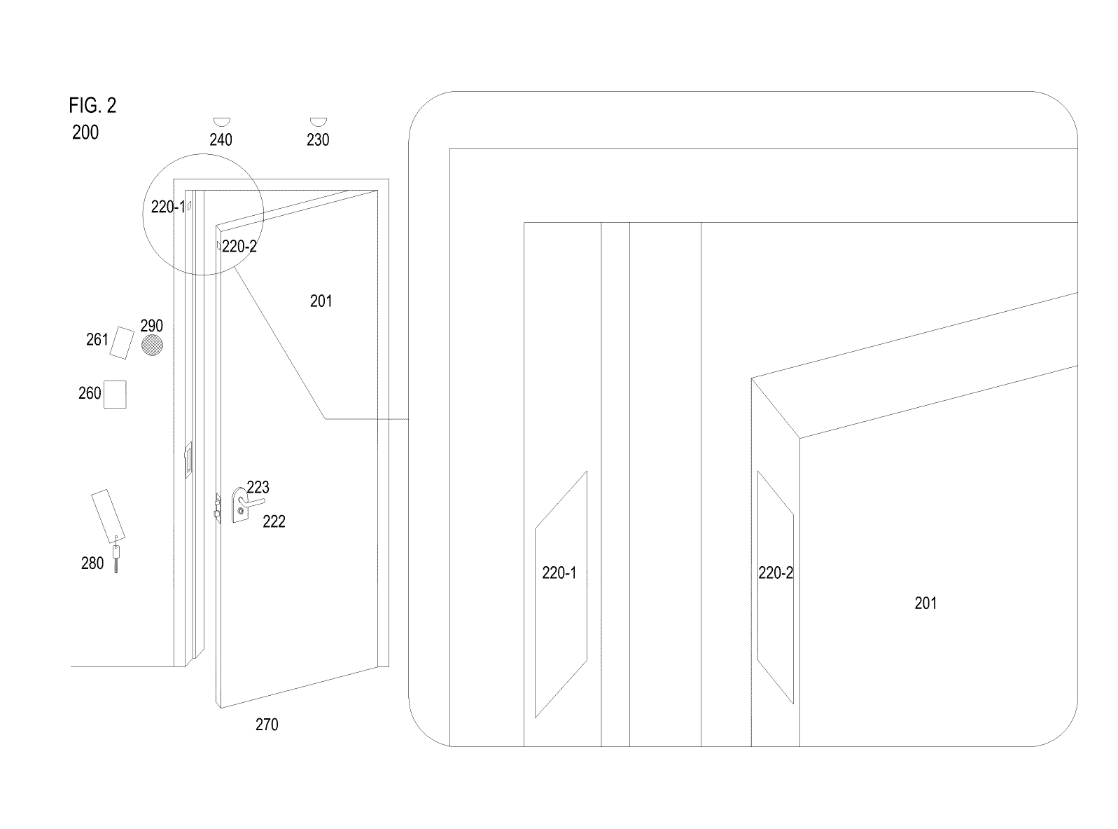

FIG. 2 illustrates various embodiments of an interactive sensor provided within a territory 200. In one embodiment, interactive sensor 220 is a contact sensor, encompassing sensing plate 220-1 mounted on door frame 204 and is communicatively linked to the controller (not shown), as well as contact plate 220-2 which is mounted on door 201. When door 201 is in the closed state, sensing plate 220-1 is faced with contact plate 220-2. When the door 201 is opened by an occupant (not shown), contact plate 220-2 moves away from sensing plate 220-1: interactive sensor 220 sends a signal to the controller, which switches one or more electrical devices (not shown) in the oncoming territory behind door 201 from a power reduction mode to an operation mode. As door 201 closes, interactive sensor 220 enters the closed state wherein contact plate 220-2 is reverted to a position facing sensing plate 220-1 while interactive sensor 220 sends a signal to the controller.

In one embodiment, an occupant behind door 201 opens a closed door 201 and enters territory 200; interactive sensor 220 sends a signal to the controller, which brightens light fixtures (not shown) installed in territory 200 before the occupant makes entry into territory 200. Once located within territory 200, the occupant is detected by occupant sensor 203.

In an alternative embodiment, an occupant exits from territory 200 by withdrawing a key card 261; interactive sensor (card reader) 260 sends a signal to the controller which brightens light fixtures (not shown) installed in a territory behind door 201 before door 201 is opened.

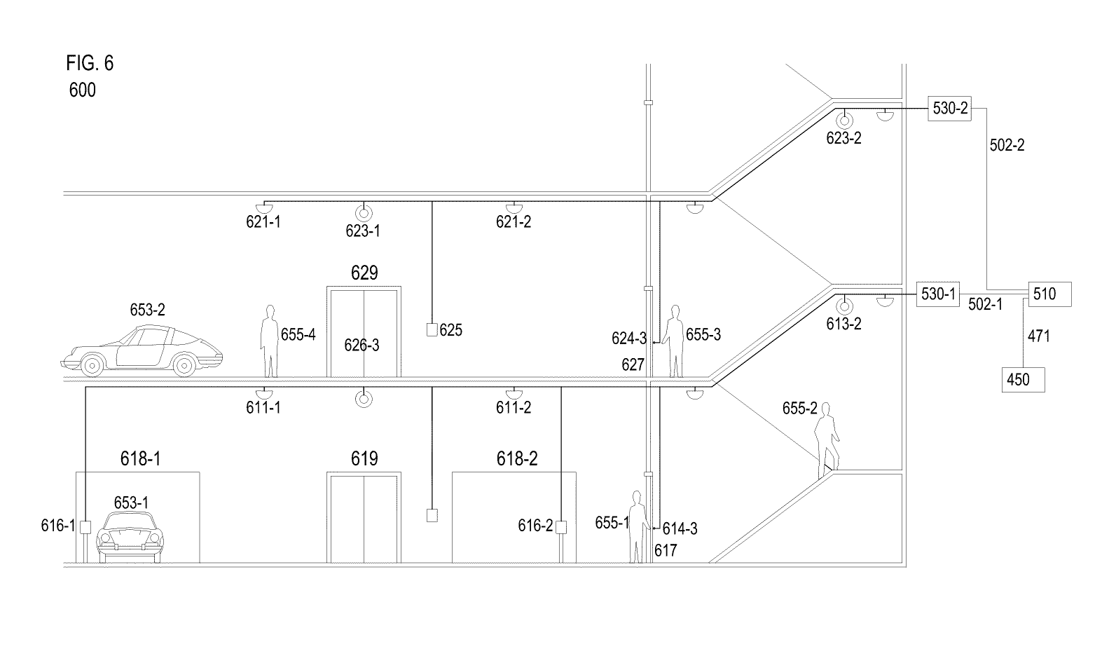

In another embodiment, a vehicle in position 653-1 entering entry 618-1, in a multi-floor parking garage environment 600 of a building as illustrated in FIG. 6; reader/sensor 616-1 captures stored vehicle information and forwards it to controller 530-1. The information containing vehicle parking space location and driver's residence unit number is processed by controller 530-1 and forwarded to controller 530-2; controller 530-1 brightens light fixtures 611-1, 611-2, whereas controller 530-2 brightens light fixtures 621-1, 621-2. Controllers 530-1 and 530-2 give a grace time period for lighting provision through the four light fixtures 611-1, 611-2, 621-1, 621-2. After the driver parks the vehicle in position 653-2 of control zone 660-2, the driver (position 655-4) walks toward doorway 626-3 for elevator service. After the driver has entered an elevator car (not shown) through doorway 626-3 and departed from the elevator car, ECS 450 sends pertinent elevator operation information through hub 510 to controllers 530-1 and 530-2. When the grace time period of lighting provision is depleted, controller 530-1 switches light fixtures 611-1 and 611-2 to a power reduction mode while controller 530-2 switches light fixtures 621-1 and 621-2 to a power reduction mode, after both controllers have completed an occupant verification process.

The interactive sensor may be provided with a variety of technologies that operate on the principle of detecting occupant initiated action followed by opening/closing of a door partitioning two territories in the occupant traversal path. Some technologies and methods constituting the interactive sensor, including but not limited to:

Door Sensor 220: comprising two metal plates, each mounted on the door and the door frame, sending signals when closed in or separated; or, comprising a spring imbedded compression switch, sending signals when compressed or released;
Capacitance Sensor 222: capacitance sensing on the metal door latch 202;
Proximity Sensor 223: non-contact sensing;
Key Card Reader 260: insertion and withdrawal of key card 261.

These technologies can be used alone or in combination to provide information about an occupant.

A variety of occupancy sensor technologies can be used to detect the traversing occupant in building territories, including (alone or in combination):

PIR sensor 230: passive infrared motion sensor;
Image Sensor 240: occupant image capturing;
Smart Floor 270: exerted weight sensing;
RFID reader (not shown): detecting an RFID tag 280 in a key holder, or, worker's permit/key card/smart card;
WiFi access point 290: detecting the WiFi adapter in a PDA, cellular phone, etc.

While the above represent various current sensor technologies, new sensors enabled by technological advancements and sensor model improvements will not alter the operation principle of the interactive sensor or limit the scope of functionality in the present utility control system and thus such improved sensors are contemplated for use in the present invention.

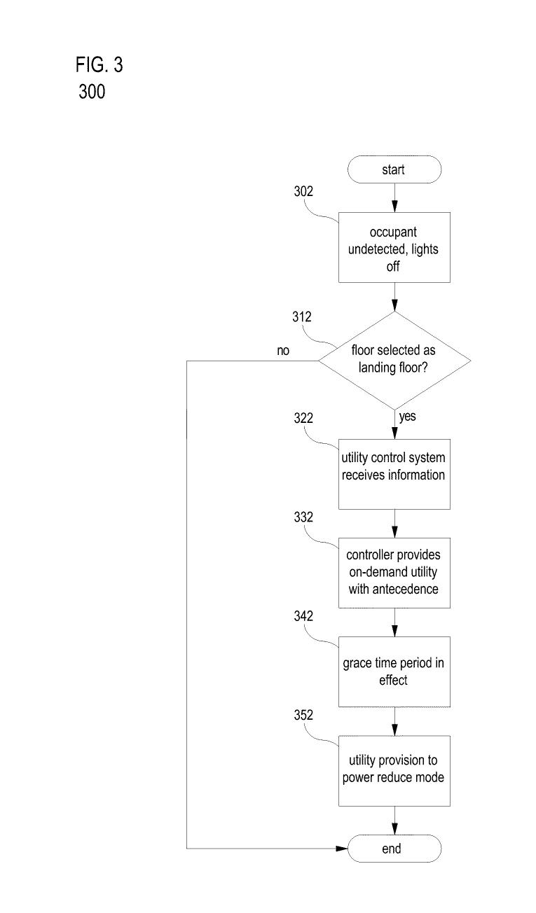

FIG. 3 is a flow diagram of a control method 300 illustrating the utility control system in operation with the ECS.

1. In step 302, the dimmed elevator hall in a building floor is unattended with occupancy.
2. As a floor not selected as a landing floor in step 312, the utility control system retains selected electrical devices in a power reduction mode.
3. Should a floor be requested as the landing floor in step 312, a respective controller receives related information from the ECS in step 322.
4. In step 332, the controller provides on-demand lighting in said landing floor anterior to car door opening through switching the selected electrical devices to an operation mode.
5. In step 342, selected light fixtures brighten to preconfigured intensities immediately anterior to car door opening. Further HVAC is optionally supplied to the landing floor in accordance with control specifications.
6. The utility control system assigns a grace time period for lighting provision to a car passenger entering the landing floor after car landing.
7. In step 352, if occupancy, in the elevator hall or car, is not detected upon depletion of the grace time period or car door closing, the utility control system switches selected electrical devices and optional HVAC to a power reduction mode in accordance with control specifications.

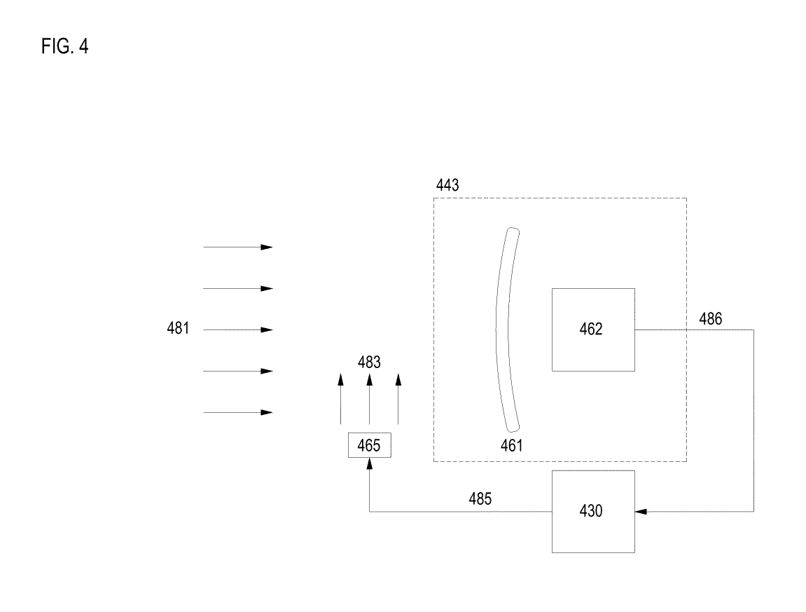

FIG. 4 demonstrates implementation of an exemplary embodiment comprising testing the operativity of a PIR sensor based occupancy sensor 443. In a regular PIR sensor operation, the PIR sensing element (not shown) within PIR module 462 receives IR radiation 481 emitted by a foreign entity (not shown) that is focused by sensor optics 461 including but not limited to Fresnel lens; PIR module 462 generates an output signal 486 and sends it to controller 430. In an operativity diagnosis process, an external IR radiation energy source 481 becomes unavailable; controller 430 sends a signal 485 to the PIR sensor based occupancy sensor 443 having an accessorized inductor 465, which emits energy 483—which relates to an energy source such as but not limited to heat. PIR module 462 responds and sends output signal 486 to controller 430, indicating operativity of occupancy sensor 443. In contrast, failure to generate an output signal 486 by PIR module 462 indicates inoperativity of occupancy sensor 443.

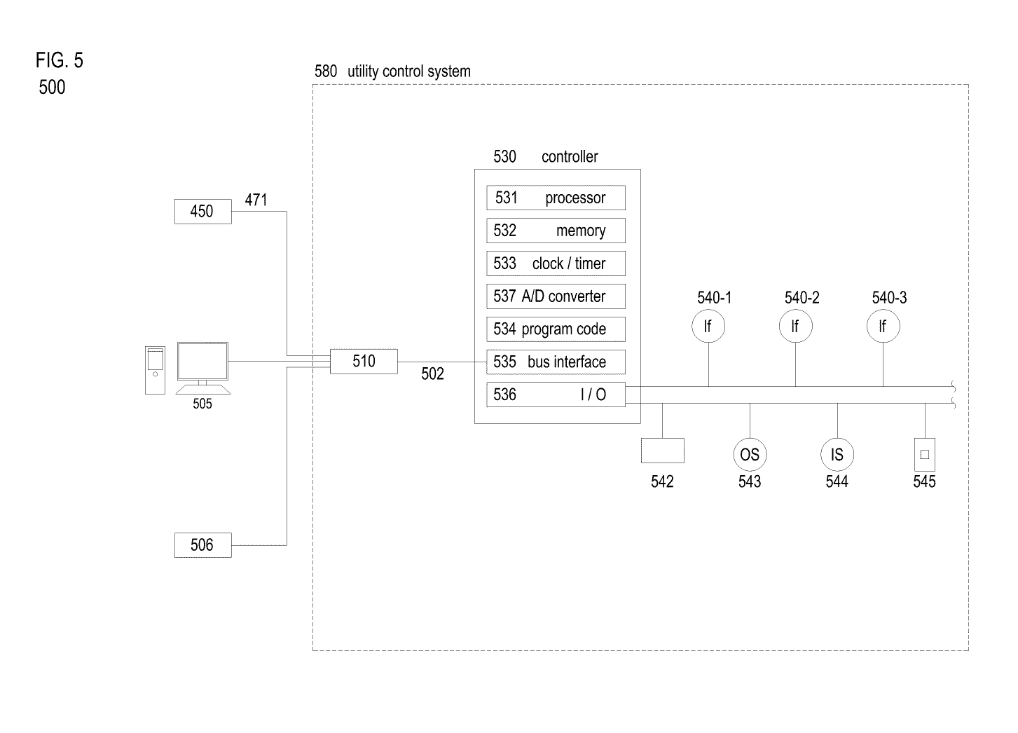

An exemplary architecture 500 is illustrated in FIG. 5, wherein a modular utility control system 580 constituting a distributed intelligence system with high granularity is communicatively linked (wired or wireless) with ECS 450, client 505 and BMS 506 through hub 510. In one embodiment, controller 530 receives configurations and commands from client 505 and/or BMS 506; in return, client 505 and BMS 506 receive real-time and archived operation information of utility control system 580.

Controller 530 comprises a processor 531, memory 532, clock and timer 533, program code 534, interface 535, input/output gateway (“I/O”) 536 and AD converter 537.

Controller 530 receives/retrieves information 471 from ECS 450 through hub 510, including one or more of the following (but not limited thereto):

number of passengers and corresponding identifications;
real-time locations of said passengers;
schedule of car landing/departing;
car load and increase/decrease in car load after car landing/departing;
real-time car landing/departing;
detected passenger identification in correspondence with active sensing technology, for example, user identification through RFID chip or WiFi adapter equipped PDA and cellular phone and similar technologies with identifiable wireless tags embedded in portable or personal belongings.

Controller 530 sends information 471 to ECS 450 through hub 510, including one or more of the following (but not limited thereto):

real-time occupancy and number of occupants in building territories including but not limited to the elevator hall, corridors, stairs and parking garage, etc.;
recorded occupancy and number of occupants in accordance with time and day.

Information 471 is utilized by controller 530 in operation, in one or more of the following ways:

activating provision of lighting illumination in territories including but not limited to the elevator hall anterior to passenger arrival from the landing elevator car,
and;
terminating said provision of lighting in territories following occupant departure through a departing elevator car.

Controller 530 receives/retrieves and processes real-time operation information from other systems through interface 535 for activation of on-demand antecedent lighting provision and occupancy verification process for ascertainment of total occupant departure from said territories in the corresponding landing floor and terminates provision of lighting and optional utilities as in HVAC, in one or more of the following ways:

via commands and operation information from client 505 and BMS 506;
via information 471 from ECS 450.

12

Through I/O 536, controller 530 controls activation and termination of utility provision by switching selected electrical devices including but not limited to a plurality of light fixtures 540, between an operation mode and a power reduction mode, including one or more of:

receiving real-time signals in accordance with clock time from elevator car detection section 542 detecting car arrival and car departure; occupancy sensor 543, interactive sensor 544, override switch 545;
brightening and dimming light fixtures 540-1, 540-2, 540-3.

Processor 531 processes incoming signals via I/O 536 and executes preinstalled programs in conformity with program code 534. Data is stored in memory 532 while commands are sent or executed in conformity with clock and timer 533. Communications are performed via interface 535 with other systems that are linked to hub 510. Incoming analog signals are converted to digital data by AD converter 537.

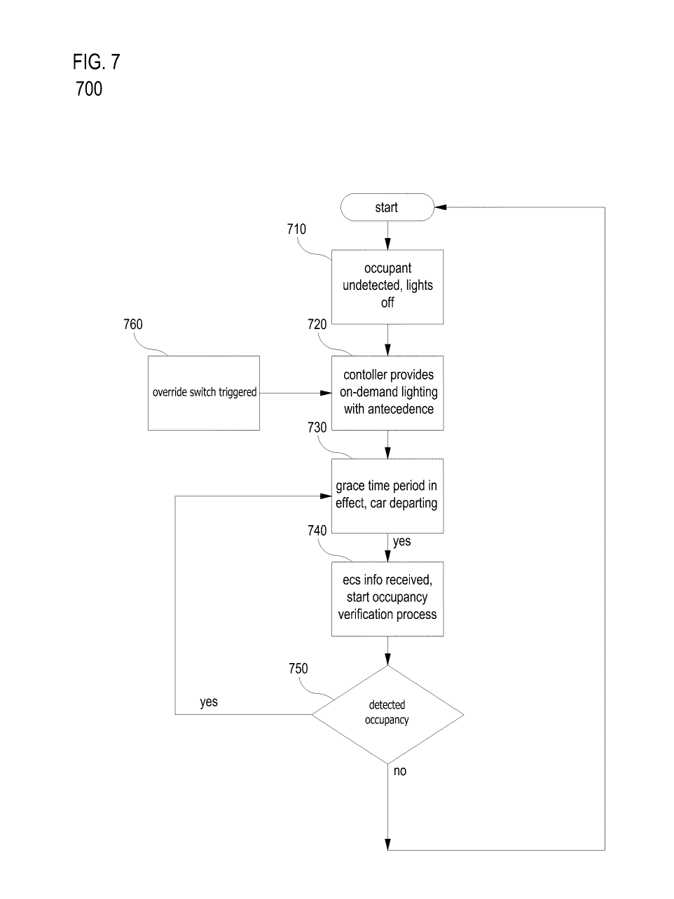

In FIG. 7, a flow diagram illustrates illumination extinguishment in a territory upon completion of the occupancy verification process in control method 700. Referring to building environment 600 in FIG. 6, controller 530-2 monitors occupancy in elevator hall 629 through occupancy sensor 623-1; wherein dynamic partitions are in place: including elevator doors 626-3; doors 617, 627.

In step 710, controller 530-2 activates illumination extinguishment by switching light fixtures 621-1 and 621-2 to a power reduction mode as controller 530-2 determines that occupancy is not detected in elevator hall 629.

In step 720, an occupant in position 655-3 entering the unattended elevator hall 629 triggers interactive sensor 624-3 anterior to opening door 627. Controller 530-2 activates the antecedent illumination process by switching light fixtures 621-1, 621-2 to an operation mode anterior to door 627 opening and assigns a grace time period for undisrupted illumination to the visiting occupant.

In step 730, controller 530-2 activates a count-down on said grace time period; subsequently—said occupant in position 655-4 is departing from elevator hall 629 through elevator doors 626-3 into a departing car (not shown).

In step 740, controller 530-2 receives/retrieves information 471 related to the real-time ECS 450 operation, and activates the occupancy verification process upon depletion of said grace time period, including:
activating occupancy detection in elevator hall 629 through occupancy sensor 623-1;
processing data pertaining to interaction sensors 624-1, 624-2, 624-3 for
detection of door opening (implying possibility in occupant making entry/exit);
processing selected data of information 471;
processing selected data of clock and timer 533 (FIG. 5);
analyzing occupancy within the elevator hall 629.

In addition, controller 530-2 optionally processes commands and operation information from client 505 and BMS 506, if any. Return to step 710 in the event that controller 530-2 determines to activate illumination extinguishment. Return to step 730 in the event that controller 530-2 determines that occupancy is detected within elevator hall 629.

In step 760, controller 530-2—receiving an override switch 625 signal activated by an undetected occupant 655-4 in the dimmed elevator hall 629—instantly assigns an extension time period to said occupant 655-4 and brightens light fixtures 621-1 and 621-2. The extension time period having a countdown for extension of illumination is similar to the grace time period

### CONCLUSION

It will be apparent to those skilled in the art that various modifications and variations can be made without departing from the scope or spirit of the present invention of the utility control system. The above examples are merely exemplary implementations of a particular system, with the true scope and spirit of the invention being indicated in the claims.

What is claimed is:

1. A utility control system, comprising:
a. one or more processor mounted controllers controlling lighting and/or utility provision characterized in heating, ventilation, and air conditioning (“HVAC”) in the building zone comprised of at least one common use territory;
b. at least one bus routing hub;
c. one or more light fixtures installed in said building zone controlled by said controller;
d. one or more occupancy sensors monitoring occupancy within a common use territory of said building zone;
e. an interactive sensor monitoring an occupant crossing a door partitioning two territories, wherein at least one territory is a common use territory within said building zone;
f. one or more elevator car detection sensors monitoring real-time location, landing and departure of operating elevator cars installed in the building;
g. a timer tracking duration of a time period for lighting provision and/or HVAC provision assigned to each occupant or each group of occupants making entry into said common use territory, the lighting provision and/or HVAC provision is in an operation mode during said time period.

2. The system of claim 1, wherein one or more said light fixtures are equipped with one or more lamps including the fluorescent lamp, the light emitting diode (LED), the incandescent lamp, or the halogen lamp.

3. The system of claim 1, wherein one or more said occupancy sensors are configured to detect a human occupant or a personal belonging of the human occupant, comprising:
a. a PIR sensor for detecting a human occupant;
b. an image capturing device including the cmos sensor;
c. an active signal sensor for detecting the RFID signal or the WiFi signal.

4. The system of claim 1, wherein said interactive sensor is configured to respond to an occupant-initiated action, wherein the occupant-initiated action including:
a. door opening/closing; or,
b. door handle rotation; or,
c. insertion/withdrawal/reading of a chip embedded key/key card; or,
d. activation of a door bell.

5. The system of claim 1, wherein said interactive sensor is a compression switch embedded within a door or a door frame, wherein the interactive sensor is configured to generate and send signals to one or more said controllers in response to movement of door lock components including the latch bolt, or opening/closing of the door.

6. The system of claim 1, wherein one or more said elevator car detection sensors are configured to detect location, landing and departure of elevator car and/or open/closed state of elevator car doors.

7. The system of claim 1, wherein said interactive sensor is a reader and is configured to read information stored in an electronic integrated circuit chip; wherein the electronic integrated circuit chip is embedded in a device selected from a key card or a personal electronic device.

8. A method of operating a utility control system, comprising:
a. sending signals, commands and/or information by one or more said controllers to one or more external control systems for determining the respective unique configurations and activation of separate operations;
b. receiving by one or more said controllers sensor signals, commands and/or information sent from one or more said external control systems for controlling one or more said light fixtures and/or utility provision characterized in HVAC in said building zone;
c. receiving signals by one or more said controllers sent from an occupancy sensor through a wired or wireless linkage;
d. receiving signals by one or more said controllers sent from an interactive sensor through a wired or wireless linkage;
e. receiving signals by one or more said controllers sent from elevator detection sensors through a wired or wireless linkage;
f. receiving signals by one or more said controllers sent from an override switch for time extension of lighting and/or utility provision through a wired or wireless linkage;
g. switching, by one or more said controllers, between an operation mode and a power reduction mode on electrical devices in accordance with received sensors signals, commands and/or information sent from one or more said external control systems;
h. assigning, by one or more said controllers, a time period for each detected occupant in a territory of said building zone, setting said light fixtures to operation mode during said time period, providing illumination as a utility provision within said territory.

9. A method comprising said controller utilizing sensor signals in adaptive control for automated provision of lighting and said utility in accordance with detected occupancy and clock time, comprising:
a. recording frequencies of occupants entering and exiting via the main entrance door into and out of an apartment unit in a building through sensor signals receiving from said interactive sensor and/or said occupancy sensor;
b. determining the time duration of the open state of said main entrance door;
c. determining if said tenant household has moved out of said apartment unit, in conformity with said time duration; and
d. eliminating recorded data pertaining to the vacated apartment unit used for said adaptive control;
e. determining if a new tenant household has moved into said tenant household unit thereby adjusting related data pertaining to predicted occupancy routines used for said adaptive control.

10. The system of claim 1, wherein said controller is communicatively linked with at least one elevator control system via one or more communicative linkages, wherein data encompassing operation information is sent and received between said controller of said system and said elevator control system, comprising:
a. said controller of said system sending signals and data encompassing information pertaining to system operation to one or more processor mounted control units of said elevator control system;
b. said controller of said system receiving from one or more said control units of said elevator control system signals and data encompassing information pertaining to said elevator control system operation.

11. A method of operating a utility control system utilizing information received from said elevator control system, comprising:
a. receiving signals, commands and/or information by one or more said controllers from an elevator control system controlling one or more operating elevator cars; whereas, said signals, commands and/or information are based on real-time data pertaining to traveling passengers and/or car scheduling of one or more said elevator cars;
b. sending signals, commands and/or information pertaining to occupancy and/or HVAC provision in one or more said territories of each landing floor by one or more said controllers to said elevator control system in an operation mode;
c. switching, by one or more said controllers on electrical devices, from an operation mode to a power reduction mode, or, from a power reduction mode to an operation mode, in one or more said territories in each said landing floor in accordance with signals, commands and/or information received from said elevator control system.

12. The method of operating a utility control system, wherein said controller determining occupant entry into a door partitioned, common use territory of a building zone anterior to or during the opening of said door, comprising:
a. receiving sensor signals, by said controller, sent from an interactive sensor detecting occupant-initiated action in activating a reader of an integrated circuit chip embedded entity such as a card and/or a personal electronic device, before opening a closed door; or
b. receiving sensor signals, by said controller, sent from an interactive sensor detecting occupant-initiated action in moving the knob or lever of a door lock, before opening a closed door; or
c. receiving sensor signals, by said controller, sent from an interactive sensor detecting occupant-initiated action in opening a door; or
d. receiving sensor signals, by said controller, sent from elevator detection sensors detecting the location, landing of an elevator car at a landing floor and opening of the respective elevator doors;
e. receiving signals, commands and/or information pertaining to car scheduling and/or landing by said controller, sent from an elevator control system anterior to landing of an elevator car at a landing floor and opening of the respective elevator doors.

13. The method of claim 12, further comprising said controller providing Antecedent Illumination through sending control signals to sequentially brighten selected said light fixtures in one or more said common use territories including said territory of occupant entry anterior to the occupant visual contact with said territory of occupant entry.

14. A modular utility control system controlling utility provision, the utility provision includes on-demand, antecedent lighting provision in at least one building zone, comprising:
a. a controller controlling lighting and/or said HVAC provision in at least one said building zone comprised of at least one common use territory;
b. said controller controlling at least one light fixture installed in said territory;
c. said controller receiving signals from an occupancy sensor through a first communication linkage;
d. said controller receiving signals from an interactive sensor through a second communication linkage;
e. said controller receiving signals from the elevator detection sensors through a forth communication linkage;
f. said controller receiving signals from an override switch through a fifth communication linkage;
g. said controller sending information to a client computer and receiving information from said client computer via a communication linkage;
h. said controller sending information to an elevator control system and receiving information from said elevator control system via a communication linkage;
i. said controller controlling lighting provision and/or HVAC provision in said territory of said building zone in accordance with sensor signals, preinstalled program code, preconfigurations and operation specifications, received data, commands and/or information from said client computer, and received commands and information from said elevator control system.
